(19) United States
(12) Patent Application Publication
(10) Pub. No.: US 2023/0002044 A1
(43) Pub. Date: Jan. 5, 2023

(54) A WING MOUNTING

(71) Applicant: ANIMAL DYNAMICS LTD, Oxford (GB)

(72) Inventors: Jonny PAGE, Oxford (GB); Sam SCHOEN, Oxford (GB); Alison MORRIS, Oxford (GB); Ludwig RESCH, Oxford (GB); Adrian THOMAS, Oxford (GB); Paul TROWBRIDGE, Oxford (GB); Graham STABLER, Oxford (GB); Jorge RODRIGUEZ, Oxford (GB); Anthony CHILD, Oxford (GB)

(73) Assignee: ANIMAL DYNAMICS LTD, Oxford (GB)

(21) Appl. No.: 17/642,611

(22) PCT Filed: Sep. 18, 2020
(86) PCT No.: PCT/GB2020/052274

§ 371 Date: Mar. 11, 2022

(30) Foreign Application Priority Data
Sep. 19, 2019 (GB) 1913490.7

(51) Int. Cl. B64C 39/02; B64C 33/02

(52) U.S. Cl. CPC B64C 39/024; B64C 33/02; B64C 2201/025; B64C 3/185

(57) ABSTRACT

A wing mounting, comprising: ⋅a base (11); ⋅a wing bracket (25) pivotally mounted to the base, configured to rotate relative to the base within an operational angular range; and ⋅at least one biasing element configured to bias the wing bracket away from the boundaries of the operational angular range, wherein the at least one biasing element (120) is configured to bias the wing bracket within a biasing range adjacent the respective boundaries of the operational angular range, but substantially not to bias the wing bracket within an inner angular range including the middle of the operational angular range.

### DESCRIPTION OF INVENTION

Conventional unmanned aerial vehicles (UAVs) are provided with a plurality of motors, each with a rotor attached. Rotating the rotors with the motors produces lift for the UAV. The speed (and, in some UAVs, the angle) of the motors can be individually controlled, to maneuver the UAV, providing yaw, pitch and roll control.

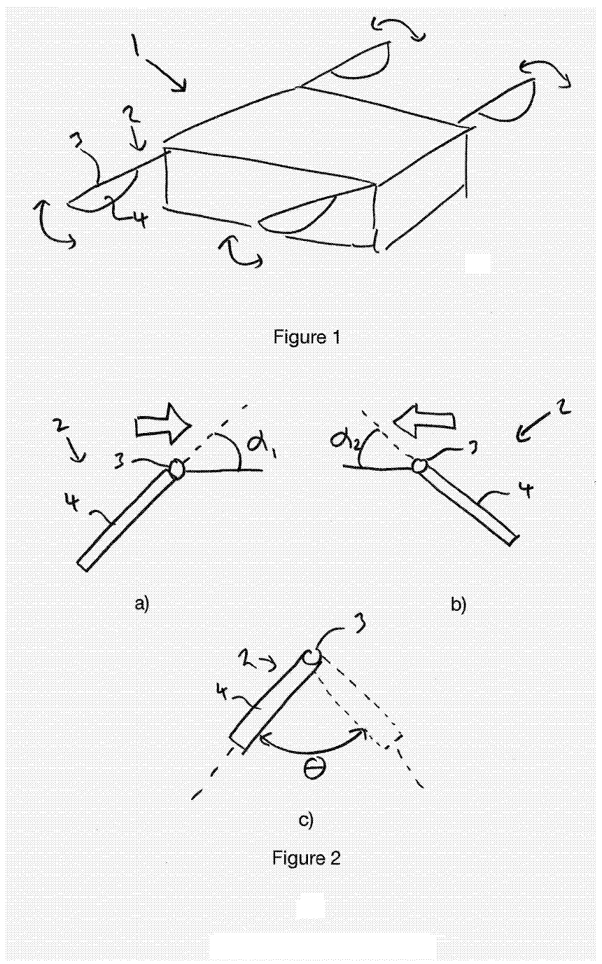

UAVs which create lift by ‘flapping’ a set of wings, rather than rotating a set of rotors, have been developed. Such a UAV 1 is schematically illustrated in FIG. 1. The spar 3 of each wing 2 may be connected to an actuator, such as a rotary drive unit (e.g. a motor) on the UAV, which is configured/driven to oscillate the wing 2 back and forth, preferably (but not essentially) within a substantially horizontal plane. A wing surface 4 extends below the spar 3. As illustrated in FIG. 2, the wing surface 4 can rotate about an axis substantially coaxial with the spar 3. Preferably, the wing surface 4 is connected to the spar 3, and the spar 3 is journaled with respect to the actuator.

The angle of attack α of the wing surface 4 is set to provide lift as the wing 2 is driven through the air (denoted by the arrows in Figures a) and b)) during each stroke of the wing 2. For each stroke, the spar 3 of the wing 2 acts as the leading edge. Although the magnitude of the angle of attack α may be substantially the same for each stroke, they are in opposing directions. Therefore, after the end of each stroke, the wing 2 needs to rotate so as to have the correct angle of attack for the return stroke. The angle θ through which the wing 2 must rotate may be calculated as 180°−(α₁+α₂), wherein α₁ is the angle of attack in the first direction, and α₂ is the angle of attack in the second (opposing) direction. For example, when α₁ and α₂ are both equal to 10°, the wing 3 must rotate through 160° when transitioning from one stroke to the next. It will be appreciated that when the angle of attack α is low, the wing 2 must rotate through a high angle θ when transitioning from one stroke to the next. The angle θ is the operational angular range of the wing 2. The wing may be mechanically limited only to rotate within the operational angular range θ. The angle of attack α may be different in each direction.

In such arrangements, there may be no active control of the angle of the wing 2 during a stroke. The angle of the wing 2 is a consequence of the movement of air over the wing surface 4, as the wing 2 is driven through a stroke by the actuator. Consequently, when the wing needs to transition from one stroke to the next, the wing may not rotate towards the required angle of attack until there is sufficient air moving over the wing surface to cause the wing to rotate.

The rate of rotation of the wing 2 between strokes affects the amount of lift generated during the stroke. If the rate of rotation is slow, then a higher percentage of the total stroke time is taken up with rotating the wing 2 and a lower percentage of the total stroke time is taken up with the wing 2 being set at the required angle of attack α, generating lift.

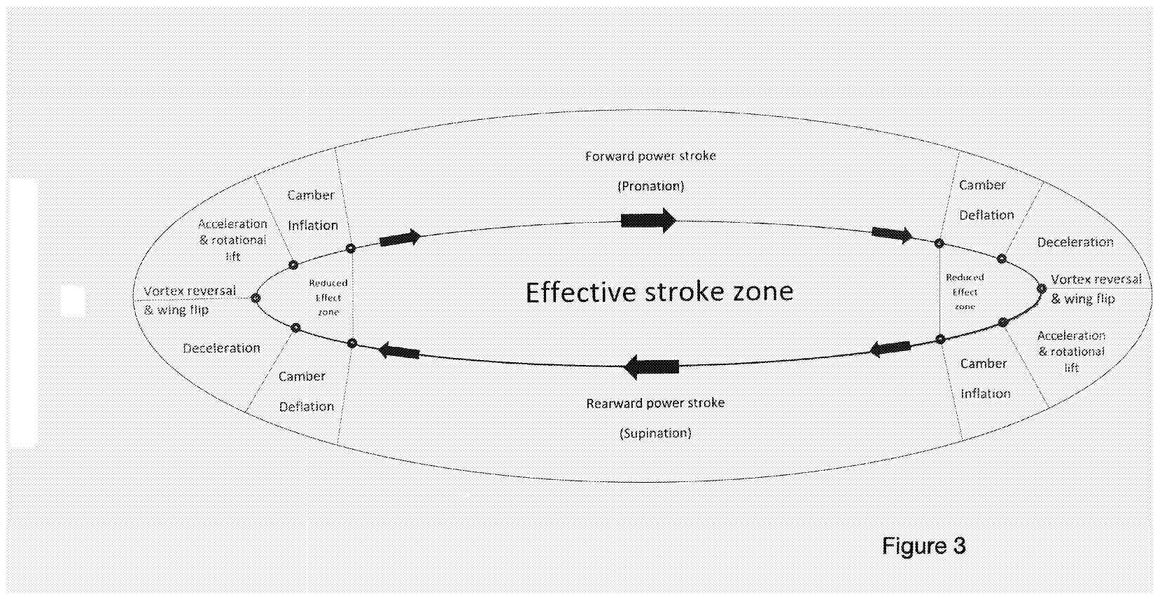

The various phases that a flapping wing 2 goes through are indicated in FIG. 3. It will be appreciated that the time spent in the power strokes should be maximised, and the time spent rotating the wing 2 (referred to as ‘reduced effect zone’ in FIG. 3) should be minimised.

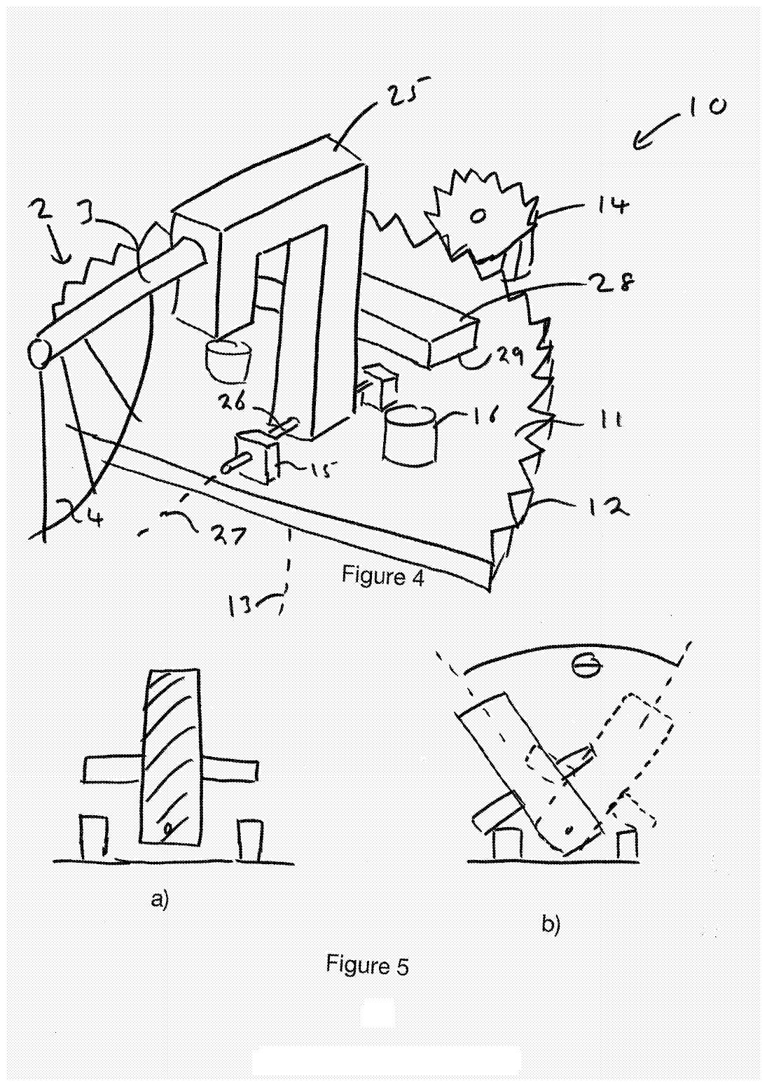

As schematically illustrated in FIG. 4, there may be provided a wing mounting 10 comprising a base 11 and a wing bracket 25 which is pivotally mounted to the base 11. The base 11 may comprise a substantially semi-circular plate having teeth 12 on the circumferential perimeter. The shape is not essential. The base 11 may be mounted to the UAV so as to be pivotable about a substantially vertical stroke axis 13. An actuator 14, such as a motor comprising a gear wheel, may engage with the teeth 12 of the base 11, such that rotation of the gear wheel causes the base 11 to rotate about the stroke axis 13. Preferably, the base 11 is caused to oscillate about the stroke axis 13 with a predetermined (adjustable) stroke rate. Of course, the use of teeth 12 and a toothed gear wheel 14 on the actuator are not essential. Any other means to oscillate the base 11 about the stroke axis 13 may be adopted, including but not limited to direct drive rotary motor, indirect rotary drive motor, linear motor, pulleys, strings, gears, belt drive etc.

The base 11 comprises two upstanding bosses 15 and two protrusions 16 which act as mechanical stops.

The wing bracket 25 comprises a pin 26 which is rotatably received in the bosses 15 of the base 11 such that the wing bracket 25 is able to rotate about a wrist axis 27. The wrist axis 27 may be substantially perpendicular to the stroke axis 13. Wrist axis 27 may be substantially horizontal.

The spar 3 of the wing 2 is secured to the top part of the wing bracket 25. The spar 3 is axially offset from the wrist axis 27, though this is not essential. By comparison, it will be noted that the schematic illustration of the wing 2 shown in FIGS. 1 and 2 comprises an arrangement in which the wrist axis 27 is substantially coaxial with the spar 3. This is not essential. All that matters is that the wing 2 can rotate about a wrist axis 27, which is preferably substantially horizontal.

The wing bracket 25 further comprises an anvil section 28, the underside of which provides one or more engaging surfaces 29.

The wing bracket 25 is constrained to rotate within an operational angular range θ by the mechanical stops 16. See FIG. 5b. During a stroke, as the wing 2 is moved through the air by the base 11 rotating about the stroke axis 13, the movement of the air over the wing surface 4 causes the wing bracket 25 to rotate about the wrist axis 27. When the wing bracket 25 rotates to a maximum extent in one direction (setting the wing 2 to the angle of attack α), further rotation of the wing 2 is prevented by the engaging surface 29 of the anvil 28 abutting the mechanical stop 16. When the wing 2 reaches the extent of the stroke, and decelerates, the air passing over the wing surface 4 reduces. Due to the mass and/or position of the centre of gravity of the wing bracket 25 and wing 2, the wing bracket 25 may move back towards the middle of the angular range (or at least away from the maximum extent). As the wing 2 starts its stroke in the opposite direction, so the wing bracket 25 will start to rotate about the wrist axis 27 in the opposite direction, until it reaches the angle of attack α in the opposite direction. The angle of attack α, and thus the operational angular range θ, is defined by the geometry of the wing bracket 25, the mechanical stops 16 and the anvil 28.

Such an arrangement effectively maintains the required angle of attack α during each stroke. However, particularly when the wing stroke rate is high, the impact of the anvil 28 on the mechanical stops 29 can create undesired noise. The anvil 28 and/or mechanical stops 16 may also be damaged by repeated impacts.

The present invention seeks to address at least one of the above problems.

Accordingly, the present invention provides a wing mounting, comprising: a base; a wing bracket pivotally mounted to the base, configured to rotate relative to the base within an operational angular range; and at least one biasing element configured to bias the wing bracket away from the boundaries of the operational angular range, wherein the at least one biasing element is configured to bias the wing bracket within a biasing range adjacent the respective boundaries of the operational angular range, but substantially not to bias the wing bracket within an inner angular range including the middle of the operational angular range.

In at least one embodiment, the biasing force provided by the at least one biasing element is adjustable.

In at least one embodiment, the at least one biasing element is provided on the base.

In at least one embodiment, the wing mounting comprises two biasing elements and the wing bracket comprises two engaging surfaces, each for engaging with a respective biasing element.

In at least one embodiment, the base comprises two threaded bores, and each biasing element comprises a grub screw having a central bore with a compression spring received therein, wherein each grub screw is received in a respective threaded bore, each compression spring for engagement with a respective engaging surface.

In at least one embodiment, the base comprises two threaded bores, and each biasing element comprises a bolt having a threaded shaft received in a respective threaded bore and an axially resilient head for engagement with a respective engaging surface.

In at least one embodiment, the height of each biasing element relative to the base is adjustable.

In at least one embodiment, the base comprises two bores, and each biasing element comprises a compression spring received in a respective bore.

In at least one embodiment, the compression spring has a non-linear spring constant.

In at least one embodiment, the wing mounting further comprises a hammer member inserted into each compression spring, comprising a shaft receivable in the compression spring and a head for engagement with a respective engaging surface.

In at least one embodiment, each compression spring comprises a cylindrical section and a conical section.

In at least one embodiment, there are two compression springs received co-axially in each respective bore.

In at least one embodiment, the at least one biasing element is provided on the wing bracket.

In at least one embodiment, the base is provided with two engaging surfaces, for engagement with the biasing element.

In at least one embodiment, the base comprises two threaded bores and a screw is provided in each threaded bore, so that the head of the screw provides said engaging surface for engagement with the biasing element.

In at least one embodiment, the height of the screw relative to the base is adjustable.

In at least one embodiment, the at least one biasing element comprises two resilient wings, each for engagement with an engagement surface of the base.

In at least one embodiment, the biasing element is a torsional spring.

In at least one embodiment, the wing bracket comprises a shaft, the torsional spring is provided around the shaft, and the torsional spring is connected to the wing bracket.

In at least one embodiment, an end of the torsional spring is arranged to engage with the base.

In at least one embodiment, the at least one biasing element is configured to bias the wing bracket towards the middle of the operational angular range.

In at least one embodiment, the at least one biasing element comprises at least one magnet, configured to repel the wing bracket away from the boundaries of the operational angular range.

In at least one embodiment, the base is provided with a first magnet and the wing bracket is provided with an opposing second magnet.

In at least one embodiment, the wing mounting further comprises a limiter substantially to prevent rotation of the wing bracket outside of said operational angular range.

In at least one embodiment, the axis of rotation is substantially horizontal.

There is also provided a thrust generator comprising: a motor; a wing mounting according to the invention, wherein the base is connected to the motor; and a wing attached to the wing bracket.

In at least one embodiment, the motor is configured to oscillate, such that the wing is caused to rotate relative to the base within the operational angular range.

In at least one embodiment, the rotational axis of the motor is substantially perpendicular to the axis of rotation of the wing bracket relative to the base.

Embodiments of the present invention will now be described, by way of non-limiting example only, with reference to the Figures in which:

FIG. 1 schematically illustrates an unmanned aerial vehicle (UAV) having a set of flapping wings;

FIGS. 2a to c schematically illustrate the motion of the wing of the UAV of FIG. 1 in use;

FIG. 3 illustrates the phases through which a flapping wing 2 passes in use;

FIG. 4 schematically illustrates a wing mounting;

FIGS. 5a and b schematically illustrate the movement of the wing mounting of FIG. 4 in use;

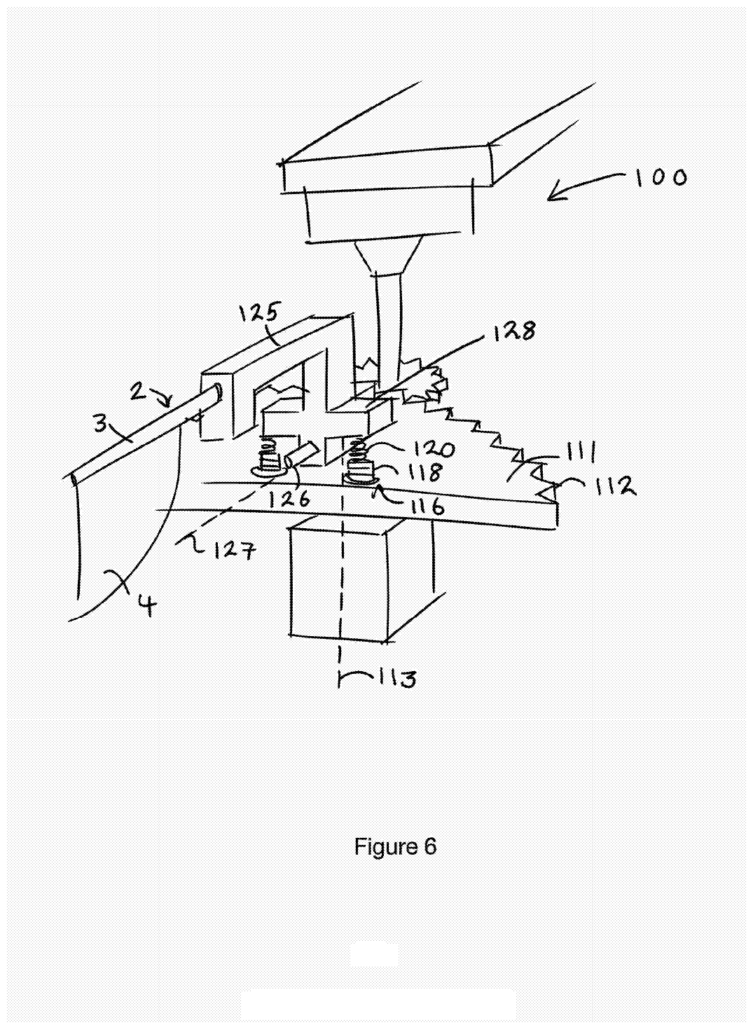

FIG. 6 illustrates a wing mounting according to one embodiment of the present invention;

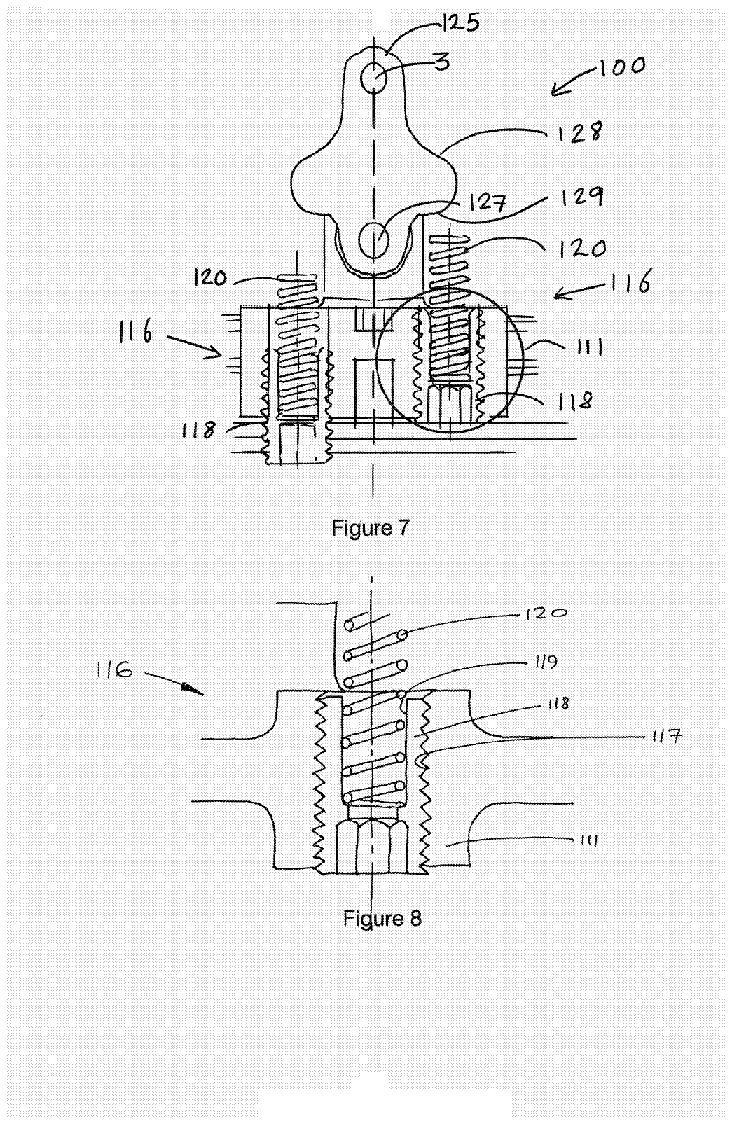

FIG. 7 illustrates a cross-section of the wing mounting of FIG. 6;

FIG. 8 is an enlarged cross-sectional view of part of FIG. 7;

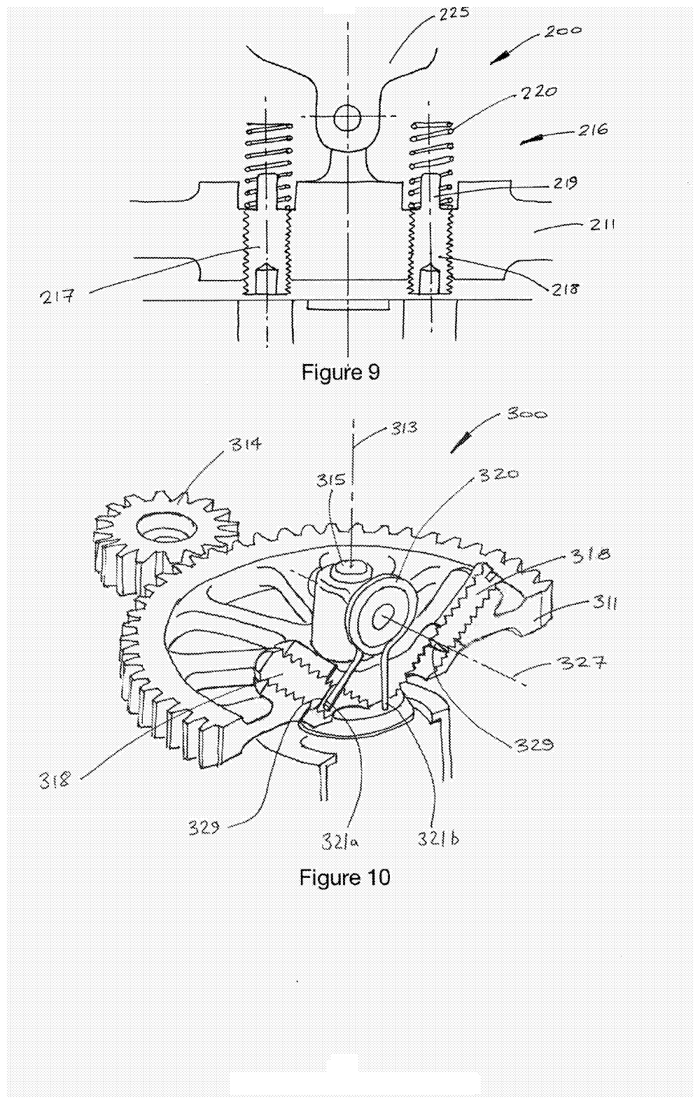

FIG. 9 illustrates a cross-section of another wing mounting embodying the present invention;

FIG. 10 illustrates a partial cross-section of another wing mounting embodying the present invention;

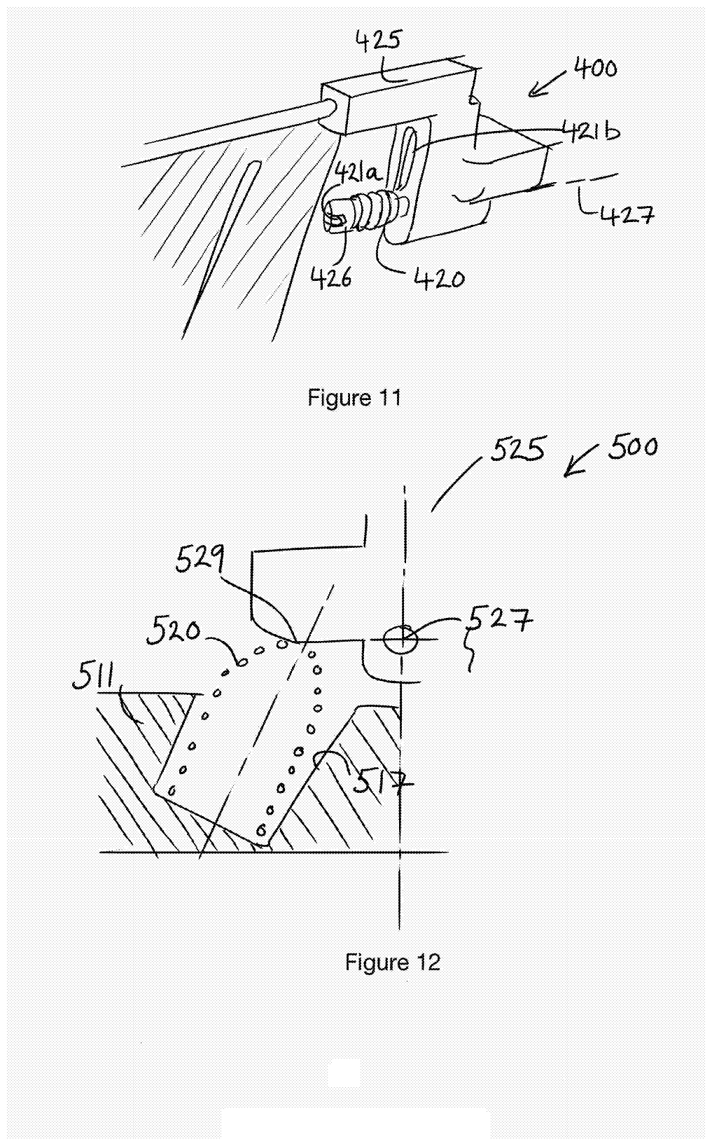

FIG. 11 schematically illustrates part of a wing mounting not according to the claimed invention;

FIG. 12 schematically illustrates a cross-section of another wing mounting according to the present invention;

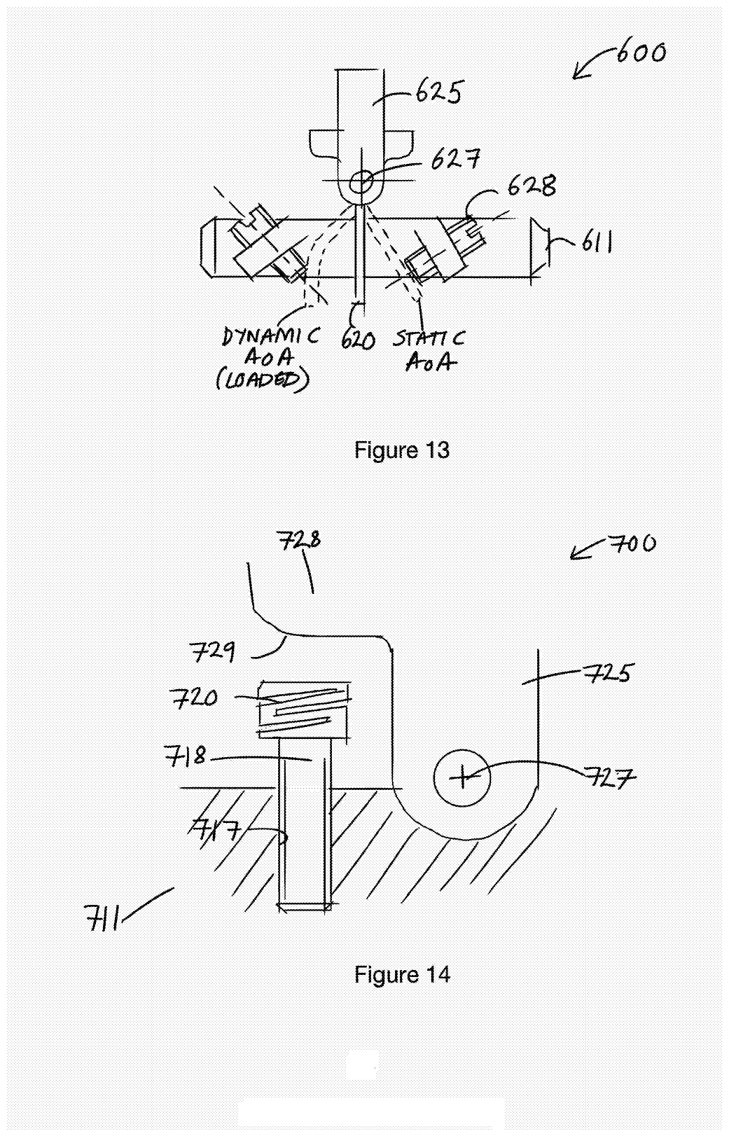

FIG. 13 schematically illustrates a cross-section of another wing mounting embodying the present invention in various positions;

FIG. 14 schematically illustrates a part of another wing mounting according to the present invention;

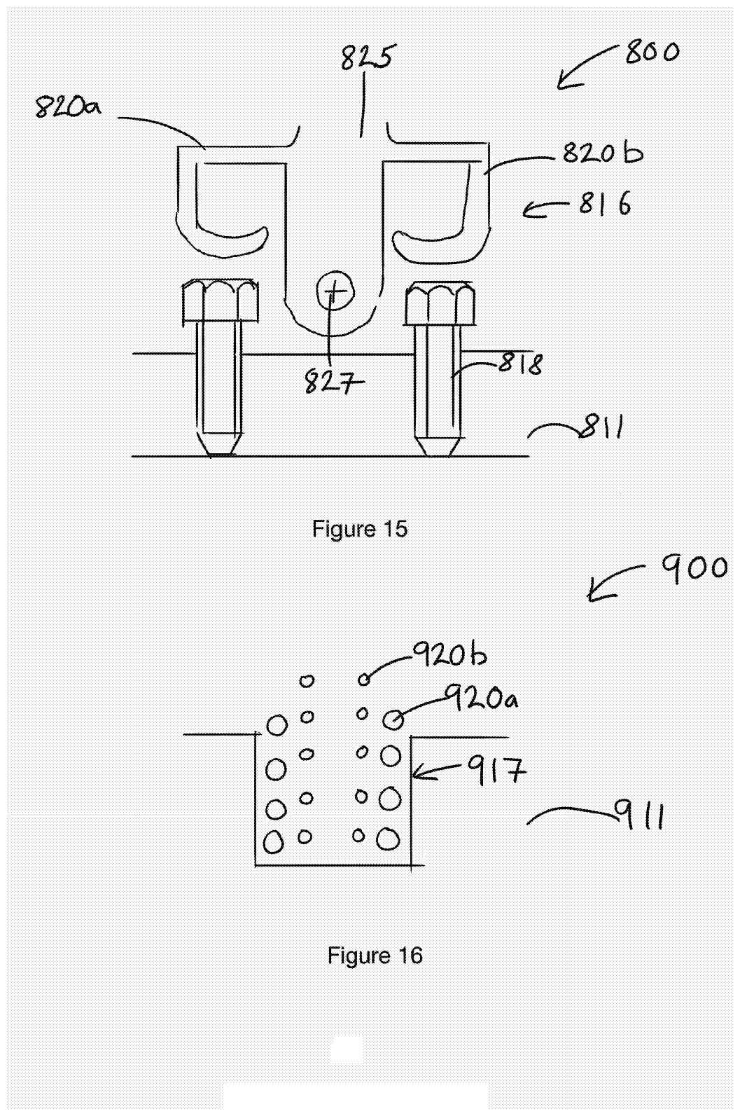

FIG. 15 schematically illustrates another wing mounting according to the present invention;

FIG. 16 schematically illustrates a cross-section of at least one biasing element of a wing mounting embodying the present invention;

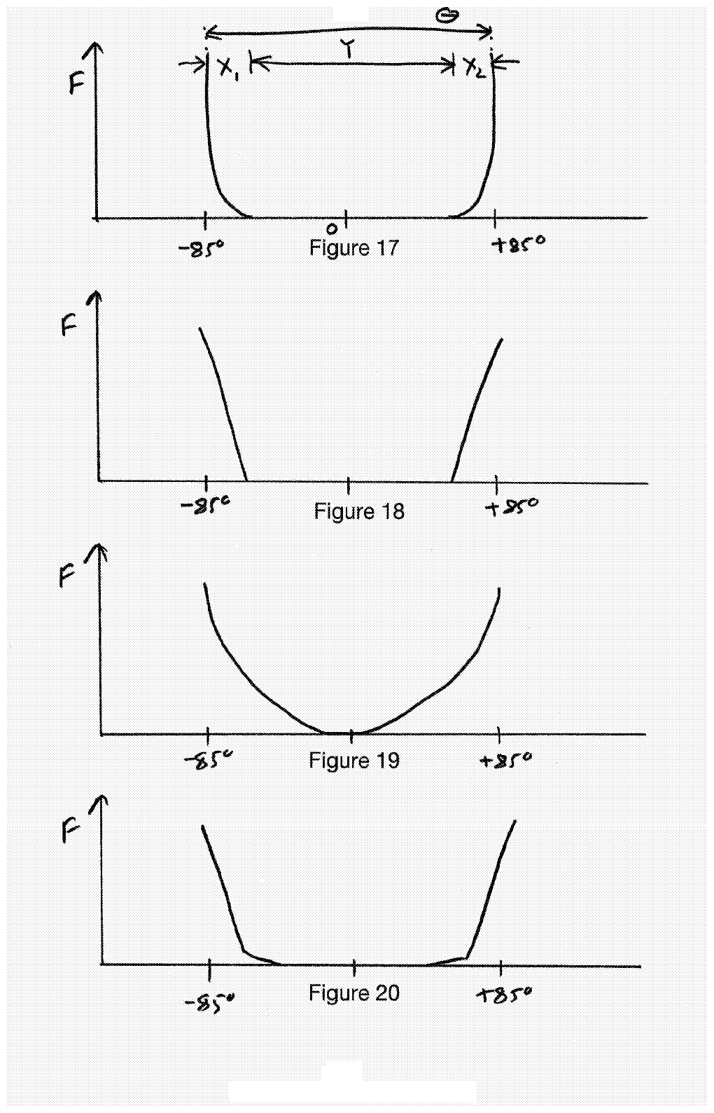

FIGS. 17 to 18 and 20 illustrate the biasing force which may be provided by at least one biasing element of a wing mounting embodying the present invention;

FIG. 19 illustrates the biasing force which may be provided by at least one biasing element of a wing mounting not according to the present invention;

FIG. 21 illustrates the forces which may be imparted on a bracket of a wing assembly not embodying the present invention; and

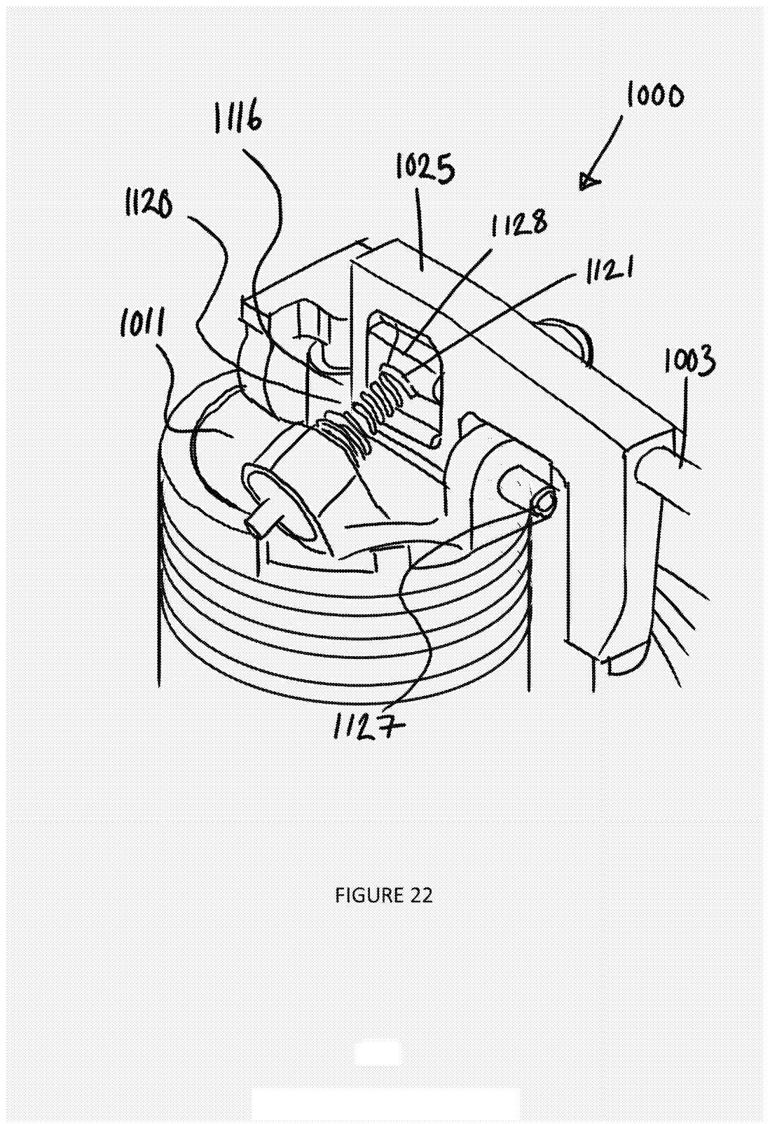

FIG. 22 illustrates a wing mounting according to another embodiment of the present invention;

In a general sense, the present invention provides an improved wing mounting, which may reduce or avoid the problems discussed above with relation to FIGS. 4 and 5, for example noise and/or damage which may be created by impacts with the mechanical stops. Embodiments of the present invention may provide additional benefits of greater efficiency, by urging a wing towards its desired angle of attack.

Broadly, the wing mounting of the present invention provides at least one biasing element to bias a wing away from the boundaries of its operational angular range.

More specifically, the wing mounting comprises: a base; a wing bracket pivotally mounted to the base, configured to rotate relative to the base within an operational angular range; and at least one biasing element configured to bias the wing bracket away from the boundaries of the operational angular range.

Various embodiments of the present invention are described below, by way of non-limiting example only. It will be appreciated that not all of the components of a described embodiment will be essential, and they may be adopted separately or in any combination.

FIGS. 6 to 8 show a wing mounting 100 for a UAV embodying the present invention. The wing mounting 100 comprises a base 111 and a wing bracket 125 pivotably mounted to the base 111. As with the arrangement shown in FIG. 4, the wing bracket 125 may be pivotably mounted relative to the base 111 by means of bosses (not shown). A pin 126 on the wing bracket 125 is journaled in the bosses, such that the wing bracket 125 is rotatable about a wrist axis 127. The wing bracket 125 is configured to rotate relative to the base 111 within an operational angular range θ.

In contrast to the wing mounting 10 shown in FIGS. 4 and 5, which comprises a mechanical stop 16, the wing mounting 100 of FIGS. 6 to 8 comprises at least one biasing element 116 which is configured to bias the wing bracket 125 away from the boundaries of the operational angular range θ. In at least one embodiment, the biasing force provided by the at least one biasing element 116 is adjustable. As with the wing mounting 10 shown in FIGS. 4 and 5, the wing mounting 100 of FIGS. 6 to 8 comprises an anvil 128 which comprises engaging surfaces 129. In the embodiment shown, there are two engaging surfaces 129 on either side of the anvil 128. The engaging surfaces 129 are configured so as to engage with the respective biasing element 116. It will be appreciated that the engaging surface 129 may simply be a part of the underside of the anvil 128, rather than being, or being provided by, a separate component. Nevertheless, the engaging surfaces 129 may be provided by an additional pad (which may be replaceable) provided on the underside of the anvil 128.

As shown in FIG. 8, the base 111 may be provided with two threaded bores 117. The biasing element 116 may comprise a grub screw 118 having a bore 119 with a compression spring 120 received therein. The bore 119 of the grub screw 118 may be a blind bore. The grub screw 118 is received in the threaded bore 117. As the grub screw 118 is rotated with respect to the base 111, the distance by which the grub screw 118 protrudes from the base 111 will be adjusted. Accordingly, to the extent that the position of the compression spring 120 relative to the grub screw 118 is fixed, adjusting the position of the grub screw 118 relative to the base 111 will likewise adjust the extent to which the top of the compression spring 120 protrudes from the base 111. Consequently, it will be appreciated that the biasing force provided by the biasing element 116 of the wing mounting 100 shown in FIGS. 6 to 8 is adjustable. In the embodiment shown in FIGS. 7 and 8, the base of the grub screw 118 is provided with a shaped recess to engage with a tool, such as a hex/allen key, to rotate the grub screw 118.

The spring constant of the compression spring 120 may be linear or non-linear.

Aside from the features disclosed above which define the invention, the arrangement as illustrated in FIG. 6 may further comprise the other features of the arrangement described with reference to FIG. 4, for example any form of drive mechanism to oscillate the base about the axis 113. Like numerals are used to denote similar components.

FIG. 17 illustrates the biasing force which may be imparted by the biasing element(s) 116 in use, as the wing bracket 125 pivots throughout the operational angular range θ. In the graph of FIG. 17, the angle is shown relative to a central position 0°. It will be noted that, in this example, the operational angular range is denoted as being 170°, meaning that the angle of attack α is 5° in each direction.

With reference to FIG. 7, in at least one embodiment of the present invention, the biasing elements 116 may not always be in contact with the anvil 128. Consequently, for at least a portion of the operational angular range θ, the biasing element 116 does not provide any biasing force on the wing bracket 125. This is illustrated in FIG. 17. The biasing element 116 is configured to bias the wing bracket 125 only within a biasing range X₁, X₂ adjacent the respective boundaries of the operational angular range θ. Consequently, the biasing elements 116 are configured not to bias the wing bracket 125 within an inner angular range Y in the middle of the operational angular range θ. By adjusting the biasing element 116 (for example by adjusting the height), the biasing range X₁, X₂ and, as a consequence, the inner angular range Y, can be adjusted.

In the graph of FIG. 17, it will be noted that the biasing force, relative to the distance from the central position, is non-linear. In FIG. 18, it is illustrated as being linear. A biasing element of a wing mounting embodying the present invention may have a linear or non-linear spring constant.

As the wing bracket 125 rotates towards a respective boundary of the operational angular range θ, the corresponding biasing element 116 will impart a biasing force on the wing bracket 125, which may be proportional to the angular position of the wing bracket 125. With reference to FIGS. 2a and b, it will be appreciated that, in use, when the wing 2 is being driven through a stroke, the wind passing over the wind surface 4 will impart a force on the wing 2, causing it to rotate about the wrist axis 127. As the wing bracket rotates to a particular angle, at which point the biasing element 116 starts to impart a biasing force, the opposing forces may eventually reach equilibrium. In at least one embodiment, the biasing force provided by the biasing element 116 will always exceed the maximum force imparted on the wing by wind loading.

For comparison with FIG. 17, FIG. 21 schematically illustrates the forces which may be imparted by the mechanical stops 16 on the bracket without the at least one biasing element of the claimed invention. At the boundaries of the operational angular range, the force imparted by the mechanical stop is substantially instant and of high magnitude—causing noise and/or damage, as discussed earlier.

In at least one embodiment of the present invention, there may also be provided a mechanical stop 16 such as that shown in FIGS. 4 and 5. The mechanical stop 16 may be separate to the biasing element, or may form a part of it. With reference to FIGS. 6 and 7, it will be appreciated that the grub screw 118 protrudes from the surface of the base 111. If, in use, the compression spring 120 is compressed beyond a certain extent, then the engaging surface 129 of the anvil 128 may impact on the top of the grub screw 118, which will provide a mechanical stop. In at least one embodiment, however, the biasing elements are configured such that the biasing force provided relative to the angular position of the wing bracket would be such that the/a mechanical stop is not needed.

FIG. 9 illustrates another wing mounting 200 embodying the present invention. The features are largely similar to those of the wing mounting 100 shown in FIG. 7, apart from the features of the biasing elements 216. As with the base 111 shown in FIG. 7, the base 211 of the embodiment shown in FIG. 9 comprises a threaded bore 217. The biasing element 216 comprises a grub screw 218 which is received in the threaded bore 117. Rather than having a blind bore 119 in the grub screw 118 like the arrangement in FIG. 6, the grub screw 218 of the wing mounting 200 shown in FIG. 9 comprises a protrusion 219 which is received inside a compression spring 220, such that a compression spring 220 is seated on the grub screw 218. As with the arrangement shown in FIGS. 6 to 8, adjustment of the grub screw 218 within the threaded aperture 217 adjusts the height of the compression spring 220 relative to the base 211. The wing mounting 200 of FIG. 9 may otherwise work substantially in the same fashion as the wing mounting 100 of FIGS. 6 to 8. As before, the spring constant of the compression spring may be linear or non-linear.

FIG. 22 illustrates another wing mounting 1000 embodying the present invention. The features are similar to those of the mountings shown in FIGS. 7 and 9. The wing mounting 1000 comprises two biasing elements 1116 (only one is clearly shown), each comprising a compression spring 1120. The arrangement further comprises a hammer member 1121 insertable into each compression spring 1120, comprising a shaft slidably receivable in the compression spring 1120 and a head for engagement with a respective engaging surface of the anvil 1128. The outer diameter of the shaft may be substantially the same as the internal diameter of the compression spring 1120. A benefit of this is that the shaft may act as a bracing member for the compression spring 1120, to prevent it from buckling under force. The outer diameter of the head is preferably larger than the internal diameter of compression spring 1120 so that the head sits on the end of the compression spring 1120 and engages with the anvil 1128. The length of the shaft may be less than the length of the compression spring 1120, so that the compression spring 1120 may be compressible.

FIG. 10 illustrates another wing mounting 300 for a UAV embodying the present invention. The base 311 of the wing mounting 300 may be substantially similar to the base 111 of the wing mounting 100 shown in FIG. 6, at least insofar as being rotatable about a stroke axis 313.

The base 311 further comprises an upstanding boss 315. The spar 3 of a wing 2 (not shown) is journaled in the boss 315 so as to be rotatable about a wrist axis 327. The wing mounting 300 further comprises a biasing element in the form of a torsional spring 320. The torsional spring 320 comprises a main helical spring section and first and second legs 321a and 321b. The first leg 321a protrudes radially from one end of the helical spring section and the second leg 321b protrudes radially from the other end of the helical spring section. The torsional spring 320 is provided around the spar 3 of the wing and a part of the helical spring body (preferably the centre) is secured to the spar 3. In this embodiment, the spar 3 of the wing comprises the wing bracket.

The wing mounting 300 of FIG. 10 further comprises two grub screws 318 which are received in threaded apertures 317 of the base 311. The grub screws 318 are adjustable so as to adjust the position of engaging surfaces 329 on the underside of the grub screw 318. As will be noted from FIG. 10, as the wing rotates about the wrist axis 327 in use, the torsional spring will also be caused to rotate about the wrist axis 327. As it does so, one of the first 321a and second 321b legs of the torsional spring 320 will engage with the engaging surface 329 of one of the grub screws 318. If the wing is caused to rotate further in the same direction about the wrist axis 327, the torsional spring 320 will provide a biasing force on the wing 2.

When the base 311 is caused to rotate about the stroke axis 313 in the opposite direction, so the wing will be caused to rotate about the wrist axis 327 in the opposite direction. It will continue to rotate until the other of the second 321b and first 321a legs of the torsional spring 320 engages with the engaging surface 329 of the other grub screw 318.

The biasing force offered by the biasing element 316 of the wing mounting 300 shown in FIG. 10 may be substantially the same as that of the other embodiments described. Accordingly, the biasing force offered may be as that illustrated in FIGS. 17 and 18, depending on whether the torsional spring provides a linear or non-linear spring constant.

FIG. 11 shows a wing mounting 400 not according to the claimed invention. As with the wing mounting 300 shown in FIG. 10, the wing mounting 400 of FIG. 11 also utilises a torsional spring 420, having a first leg 421a and a second leg 421b. The features of the wing bracket 425 may be generally similar to those of the wing bracket 25 shown in FIG. 4.

The wing bracket 425 comprises a pin 426. The wing bracket 425 may rotate relative to the pin 426. The pin 426 may be rigidly secured to the base 411.

The helical spring portion of the torsional spring 420 is provided around the pin 426. A first leg 421a is secured relative to the pin 426. In the schematic illustration shown in FIG. 11, the first leg 421a is received in a slot provided on an end of the pin 426. The second leg 421b of the torsional spring 420 may be received in a recess on the wing bracket 425.

Consequently, as the wing bracket 425 is caused to rotate about the wrist axis 427, the torsional spring 420 serves to impart a biasing force on the wing bracket 425, opposing the rotation. Because the first 421a and second 421b ends of the torsional spring 420 are secured at either end, at all times, it will be appreciated that the torsional spring 420 provides a biasing force whenever the wing bracket 425 is caused to deviate from its central position. The spring constant may be linear or non-linear.

As compared to the wing mountings 100, 200, 300 as described above, the wing mounting 400 of FIG. 11 is always biased towards the center. It is self-centering. FIG. 19 illustrates the biasing force which may be imparted by the torsional spring 420 relative to the angular position of the wing bracket 425 (in this example, with a non-linear spring constant). It will be noted that, as compared to the graphs of FIGS. 17 and 18, there is no inner angular range Y in which the biasing element is configured not to bias the wing bracket. FIG. 19 illustrates the spring constant as being non-linear, but this is not essential. It may be linear or non-linear.

FIG. 12 illustrates part of another wing mounting 500 embodying the present invention. The wing mounting 500 is generally similar to the wing mounting 100, 200 described above. However, rather than adopting a grub screw, the wing mounting 500 of FIG. 12 provides a compression spring 520 in a bore 517 in the base 511.

The compression spring 520 comprises a cylindrical (tubular) lower section and a conical upper section. Consequently, the overall spring constant of the compression spring 520 may be non-linear. The biasing force provided by the compression spring 520 may differ according to the extent of compression. The resiliency of the cylindrical section of the compression spring 520 may be different to the resiliency of the conical section of the compression spring 520. It will be appreciated that in FIG. 12 only one of the compression springs 520 is shown. The reader will appreciate that there will be another compression spring 520 on the other side of the wing bracket 525. In another embodiment (not shown), the compression spring may take other forms (for example cylindrical, conical or barrel shaped). The top of the compression spring may comprise a cap.

FIG. 16 illustrates another biasing member 920 of a wing mounting 900 embodying the present invention. This embodiment may be similar to the wing mounting 500 shown in FIG. 12, in that a compression spring is received in a bore in the base. In this embodiment, there is provided a first compression spring 920a and a second compression spring 920b, which are both received in the same bore 917 in the base 911. The diameter of the first compression spring 920a may be larger than the diameter of the second compression spring 920b. Consequently, the second compression spring 920b may be received within the first compression spring 920a. The helical direction of the first compression spring 920a is preferably opposite to that of the second compression spring 920b. This may aid assembly and/or reduce or prevent the chance of the springs binding during operation.

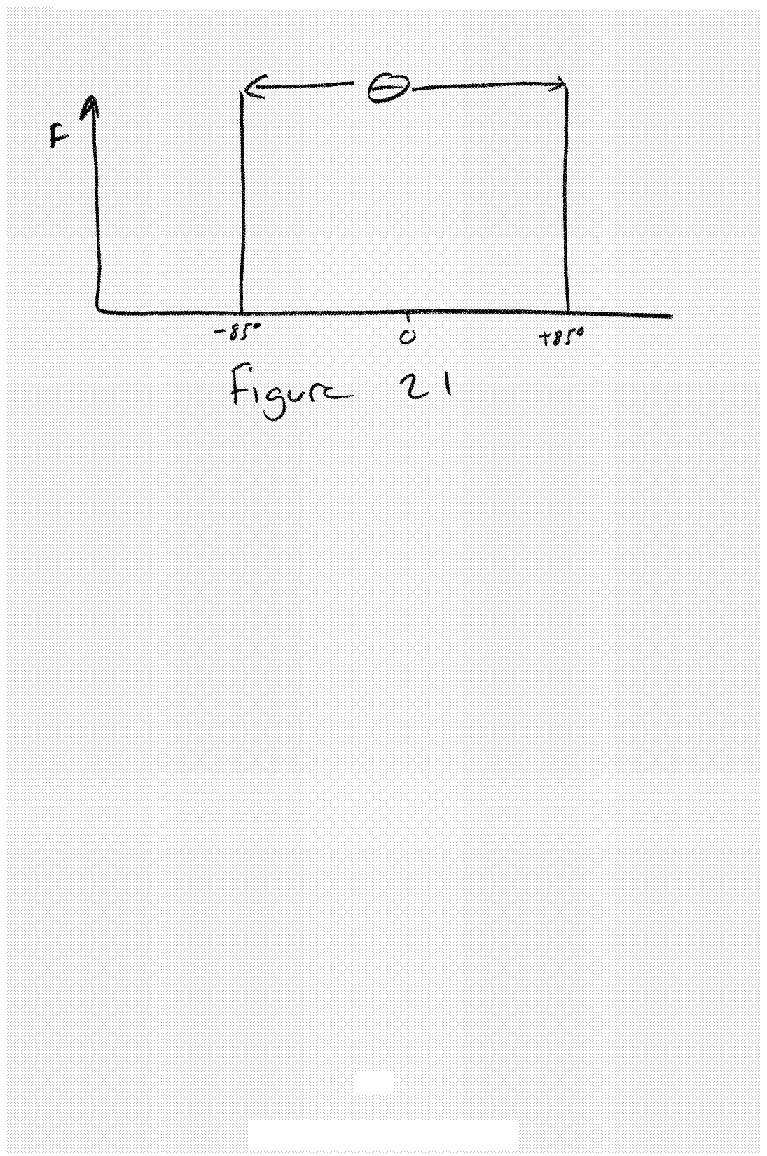

The use of the biasing element 520 of FIG. 12 or 920a, 920b of FIG. 16 may provide a non-linear spring constant. Owing to the geometry of the compression springs, they may provide a complex non-linear spring constant which changes depending on the angular position of the wing bracket relative to the wrist axis. FIG. 20 schematically illustrates the biasing force which may be imparted by a biasing element with a complex non-linear spring constant.

FIG. 13 schematically illustrates another wing mounting 600 embodying the present invention. Similar to the wing mounting 300 illustrated in FIG. 10, the base 611 is provided with a pair of grub screws 628 which are adjustable. A biasing element, preferably a resilient member 620, is secured relative to the wing bracket 625. As the wing bracket 625 rotates within the operational angular range θ, the biasing element 620 is caused to engage with the engaging surface of a respective grub screw 628. As the wing bracket 625 rotates further about the wrist axis 627, the biasing element 620 is caused to deform, which provides a reactionary biasing force, as illustrated by the dotted lines on the left-hand side of FIG. 13. The wing mounting 600 shown in FIG. 13 may behave in substantially the same fashion as the wing mountings 100, 200, 300 and 500.

FIG. 14 illustrates part of another wing mounting 700 embodying the present invention. The base 711 comprises a threaded bore 717. A biasing element 716 comprises a bolt 718 having a threaded shaft receivable in the threaded bore 717. The biasing element 716 further comprises an axially resilient head 720 for engagement with an engaging surface 729 of the anvil 728. The resilient head 720 provides compliance such that as it engages the engaging surface 729, further rotation of the wing bracket 725 causes the resilient head to deform which, in turn, provides a reactionary biasing force on the engaging surface 729.

FIG. 15 illustrates part of another wing mounting 800 embodying the present invention. In this embodiment, the biasing element 816 is provided on the wing bracket 825. The base 811 is provided with two grub screws 818 or bolts which protrude from the base 811. The position of the grub screws 818 relative to the base 811 may be adjusted.

The biasing element 816 comprises two resilient extensions 820a, 820b. Each of the extensions is generally J-shaped (and mirror images of one another). The resilient extensions 820a, 820b are compliant such that as they engage with the top of the screws 818, when the wing bracket 825 rotates about the wrist axis 827, their compliancy causes a reactionary biasing force on the wing bracket 825.

In another embodiment of the present invention (not illustrated) the biasing element may comprise at least one magnet, which is configured to repel the wing bracket away from the boundaries of the operational angular range θ. The wing bracket may be provided with a first magnet and the base may be provided with at least one opposing magnet.

In the embodiments described above and illustrated in the attached Figures, a biasing element is disclosed as being provided either on the base or wing bracket. It will be appreciated by the reader that the opposite arrangement is also possible. For example, with reference to FIG. 7, rather than providing the biasing elements in the base, the skilled person will appreciate that the anvil 128 can be reconfigured so as to receive the biasing elements in bores within the anvil 128, which then engage with an upper surface of the base 111. Springs may protrude from the underside of the anvil and which engage with the top of a corresponding grub screw protruding from the base.

In at least one embodiment, the wing mounting is configured so as to minimize the wing inertia experienced at the point of wing rotation at the end of a wing stroke. For example, the centre of gravity of the combined arrangement of the wing bracket and wing may be configured to be substantially incident with the wrist axis 27.

The present invention further provides a thrust generator for a UAV comprising a motor, a wing mounting embodying the present invention and a wing attached to the wing bracket.

In at least one embodiment, there is provided a UAV comprising a plurality of wings, a corresponding plurality of wing mountings according to the claimed invention, and a wing attached to the wing bracket of each wing mounting. There may be 2, 4, 6, 8, 10 or more wings.

Generally, embodiments of the present invention seek to assist the wing rotation at the end of each stroke. Consequently, the size of the effective stroke zone, relative to the reduced effect zone, may be increased.

The biasing element serves to store potential energy during a stroke. At the end of the stroke, the potential energy stored in the biasing element is converted into kinetic energy which helps to rotate the wing ready for the stroke in the opposing direction.

Assisting the wing rotation at the end of each stroke may increase the time that the wing is in the correct position to create the required lift, thus making the system more efficient.

A biasing element is something which provides a biasing force. In this description, example biasing elements include a spring, flexible member and a compliant head. Other biasing elements are possible, including the use of rubber or anything which has resiliency.

In the illustrated embodiments, the operational angular range θ is depicted as being symmetrical about the vertical axis (i.e. the wing surface is substantially vertical when in the centre of the operational angular range θ). This is not essential. The alignment of the operational angular range θ may be different to that illustrated, for example: symmetrical about the horizontal axis or any other axis.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

Although certain example embodiments of the invention have been described, the scope of the appended claims is not intended to be limited solely to these embodiments. The claims are to be construed literally, purposively, and/or to encompass equivalents.

1-25. (canceled)

26. A wing mounting, comprising:
a base;
a wing bracket pivotally mounted to the base, configured to rotate relative to the base within an operational angular range; and
at least one biasing element configured to bias the wing bracket away from the boundaries of the operational angular range, wherein the at least one biasing element is configured to bias the wing bracket within a biasing range adjacent the respective boundaries of the operational angular range; but substantially not to bias the wing bracket within an inner angular range including the middle of the operational angular range.

27. A wing mounting according to claim 26, wherein the biasing force provided by the at least one biasing element is adjustable.

28. A wing mounting according to claim 26, wherein the at least one biasing element is provided on the base.

29. A wing mounting according to claim 28, comprising two biasing elements and wherein the wing bracket comprises two engaging surfaces, each for engaging with a respective biasing element.

30. A wing mounting according to claim 29, wherein the base comprises two threaded bores, and each biasing element comprises a grub screw having a central bore with a compression spring received therein, wherein each grub screw is received in a respective threaded bore, each compression spring for engagement with a respective engaging surface, or wherein the base comprises two threaded bores, and each biasing element comprises a bolt having a threaded shaft received in a respective threaded bore and an axially resilient head for engagement with a respective engaging surface, optionally wherein the height of each biasing element relative to the base is adjustable.

31. A wing mounting according to claim 29, wherein the base comprises two bores, and each biasing element comprises a compression spring received in a respective bore, optionally wherein the compression spring has a non-linear spring constant.

32. A wing mounting according to claim 30, further comprising a hammer member inserted into each compression spring, comprising a shaft receivable in the compression spring and a head for engagement with a respective engaging surface.

33. A wing mounting according to claim 31, wherein each compression spring comprises a cylindrical section and/or a conical section or wherein there are two compression springs received co-axially in each respective bore.

34. A wing mounting according to claim 26, wherein the at least one biasing element is provided on the wing bracket.

35. A wing mounting according to claim 34, wherein the base is provided with two engaging surfaces, for engagement with the biasing element.

36. A wing mounting according to claim 35, wherein the base comprises two threaded bores and a screw is provided in each threaded bore, so that the head of the screw provides said engaging surface for engagement with the biasing element, optionally wherein the height of the screw relative to the base is adjustable.

37. A wing mounting according to claim 35, wherein the at least one biasing element comprises two resilient wings, each for engagement with an engagement surface of the base.

38. A wing mounting according to claim 34, wherein the biasing element is a torsional spring.

39. A wing mounting according to claim 38, wherein the wing bracket comprises a shaft, the torsional spring is provided around the shaft, and the torsional spring is connected to the wing bracket, optionally wherein an end of the torsional spring is arranged to engage with the base.

40. A wing mounting according to claim 26, wherein the at least one biasing element is configured to bias the wing bracket towards the middle of the operational angular range.

41. A wing mounting according to claim 26, wherein the at least one biasing element comprises at least one magnet, configured to repel the wing bracket away from the boundaries of the operational angular range, optionally wherein the base is provided with a first magnet and the wing bracket is provided with an opposing second magnet.

42. A wing mounting according to claim 26, further comprising a limiter substantially to prevent rotation of the wing bracket outside of said operational angular range.

43. A wing mounting according to claim 26, wherein the axis of rotation is substantially horizontal.

44. A thrust generator comprising:
a motor;
a wing mounting according to claim 26, wherein the base is connected to the motor; and
a wing attached to the wing bracket.

45. A thrust generator according to claim 44, wherein the motor is configured to oscillate, such that the wing is caused to rotate relative to the base within the operational angular range, optionally wherein the rotational axis of the motor is substantially perpendicular to the axis of rotation of the wing bracket relative to the base.
